(19) United States
(12) Patent Application Publication
(10) Pub. No.: US 2025/0168737 A1
(43) Pub. Date: May 22, 2025

(54) ENHANCED HANDOVER FOR PDU SET LEVEL HANDLING

(71) Applicant: QUALCOMM Incorporated, San Diego, CA (US)

(72) Inventors: Hyun Yong LEE, San Diego, CA (US); Mickael MONDET, Louannec (FR); Huilin XU, Temecula, CA (US); Linhai HE, San Diego, CA (US); Peerapol TINNAKORNSRISUPHAP, San Diego, CA (US); Prashanth Haridas HANDE, San Diego, CA (US); Diana MAAMARI, San Diego, CA (US); Prasad Reddy KADIRI, San Diego, CA (US)

(21) Appl. No.: 18/513,344

(22) Filed: Nov. 17, 2023

(51) Int. Cl. H04W 36/36; H04W 36/00; H04W 36/24

(52) U.S. Cl. CPC H04W 36/362; H04W 36/0072; H04W 36/00837; H04W 36/249

(57) ABSTRACT

Certain aspects of the present disclosure provide method for wireless communications by a user equipment (UE), comprising receiving, from a first network entity, a message indicating a handover of the UE from a source cell to a target cell and performing the handover conditional upon completion of delivery of the first set of packets from the first network entity to the UE.

### BACKGROUND

### Field of the Disclosure

Aspects of the present disclosure relate to wireless communications, and more particularly, to techniques for handing a wireless device from one cell to another, in a manner that considers quality of service (QOS) parameters of protocol data unit (PDU) sets.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a user equipment (UE). The method includes receiving, from a first network entity, a message indicating a handover of the UE from a source cell to a target cell; and performing the handover conditional upon completion of delivery of the first set of packets from the first network entity to the UE.

Another aspect provides a method for wireless communications by a first network entity. The method includes obtaining a first set of packets to be delivered to a user equipment (UE); and performing at least one action to delay handover of the UE from a serving cell to a target cell until completion of delivery of the first set of packets to the UE.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a call flow diagram for a handover (HO).

FIG. 6 depicts a call flow diagram for a conditional handover (CHO).

FIG. 7 depicts an example scenario where aspects of the present disclosure may be utilized.

FIG. 8 depicts an example traffic flow that may be processed in accordance with aspects of the present disclosure.

FIGS. 9A and 9B depict example traffic flows without and with a handover, respectively.

FIG. 10 depicts an example traffic flow processed in accordance with aspects of the present disclosure.

FIGS. 11A and 11B depict example traffic flows with delayed handover messages.

FIG. 12 depicts an example traffic flow processed in accordance with aspects of the present disclosure.

FIG. 13 depicts an example traffic flow processed in accordance with aspects of the present disclosure.

FIG. 14 depicts a method for wireless communications.

FIG. 15 depicts a method for wireless communications.

FIG. 16 depicts aspects of an example communications device.

### DETAILED DESCRIPTION

Aspects of the present disclosure relate to wireless communications, and more particularly, to techniques for handing a wireless device from one cell to another, in a manner that considers quality of service (QOS) parameters of protocol data unit (PDU) sets.

5G new radio (NR) provides a high-speed, low-latency and high-reliability wireless connectivity which can enable immersive virtual reality (VR), augmented reality (AR) and extended reality (XR) multimedia and cloud computing services. XR/multimedia data services may involve various user interface (UI) devices, such as AR Glasses and VR Head-Mounted Displays (HMDs) used in Cloud-based Gaming and Cloud-based artificial intelligence (AI). These advanced multimedia applications may have strict system requirements. Requirements include high data rate and low latency to better allow a targeted 99% of XR traffic to be delivered within a packet delay budget (PDB) (e.g., 10 ms), and low power consumption to better save power on multimedia devices (e.g., less than 1 W for AR glasses/headsets).

XR applications often consume data in relatively large units, referred to as protocol data unit (PDU) sets that represent a set of Internet Protocol (IP) packets, rather than single IP packets. In both uplink and downlink, certain features may rely on the notions of PDU Set and Data Burst. PDU sets and Data Bursts generally enable a radio access network (RAN) to identify the PDUs which carry content that the application processes as a single unit (e.g., an application data unit/ADU that represents a portion of an image, an audio frame) and the duration of a data transmission, respectively. A Data Burst may include different PDU sets that should be delivered to a user equipment (UE) with the same deadline (e.g., all slices of a video frame).

Applications typically specify transport layer requirements on a PDU Set (e.g., on “slices” of video frames). For example, an application may specify that PDU sets should be delivered within a certain timeframe. Similar to a PDB for individual packets, this timeframe for PDU sets may be referred to as a PDU set delay budget (PSDB).

One potential challenge in meeting specified PSDBs when delivering PDU sets is the occurrence of handover (HO) procedures. HO procedures are generally designed to provide seamless/lossless data to a UE, allowing the UE to maintain adequate signal quality while moving across multiple cells. During an HO from a source cell to a target cell, data delivery to the UE may be interrupted. However, if a HO occurs during (in the middle of) a PDU set transmission, it may be difficult to meet the specified PSDB due to the HO interruption time.

Aspects of the present disclosure, however, provide enhanced HO mechanisms that may be designed to help satisfy PDU-set level delivery requirements during mobility. For example, in some cases, if a HO occurs during delivery of a PDU set, a network entity (e.g., a gNB) of a source cell may perform at least one action to delay handover of the UE to a target cell until completion of delivery of PDU set to the UE. In some cases, a UE may delay performing a handover conditional upon completion of delivery of a PDU set.

By helping satisfy QoS parameters of PDU sets, while supporting mobility of a UE between cells, aspects of the present disclosure may improve system performance and enhance overall user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

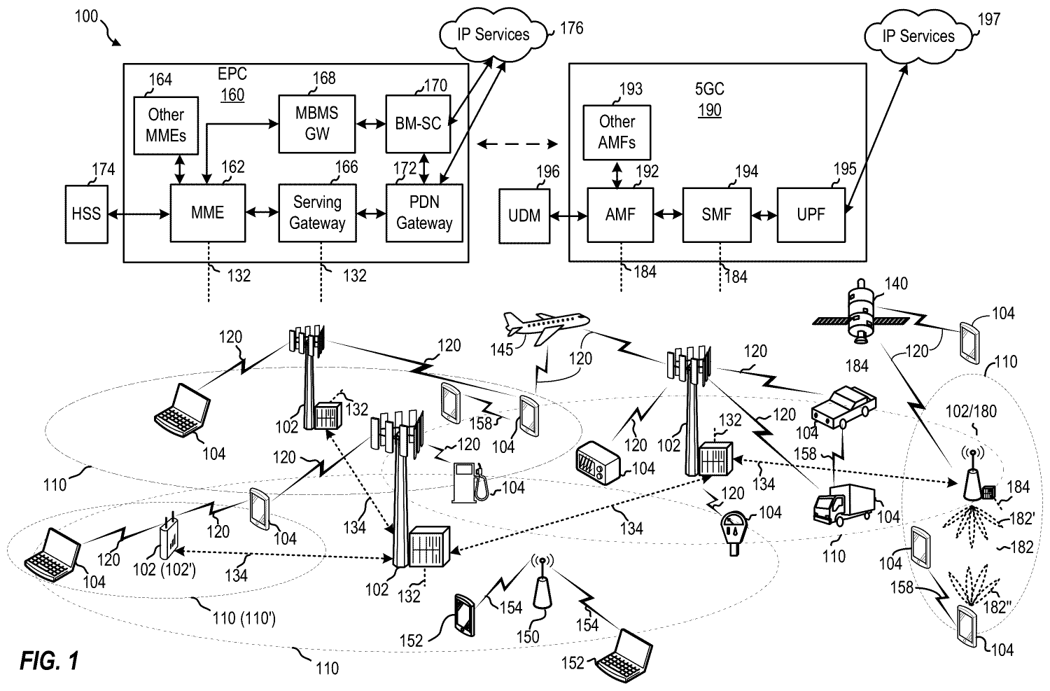

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, reality augmentation device (augmented reality (AR), extended reality (XR), or virtual reality (VR)), or any other suitable device that is configured to communicate via a wireless or wired medium.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

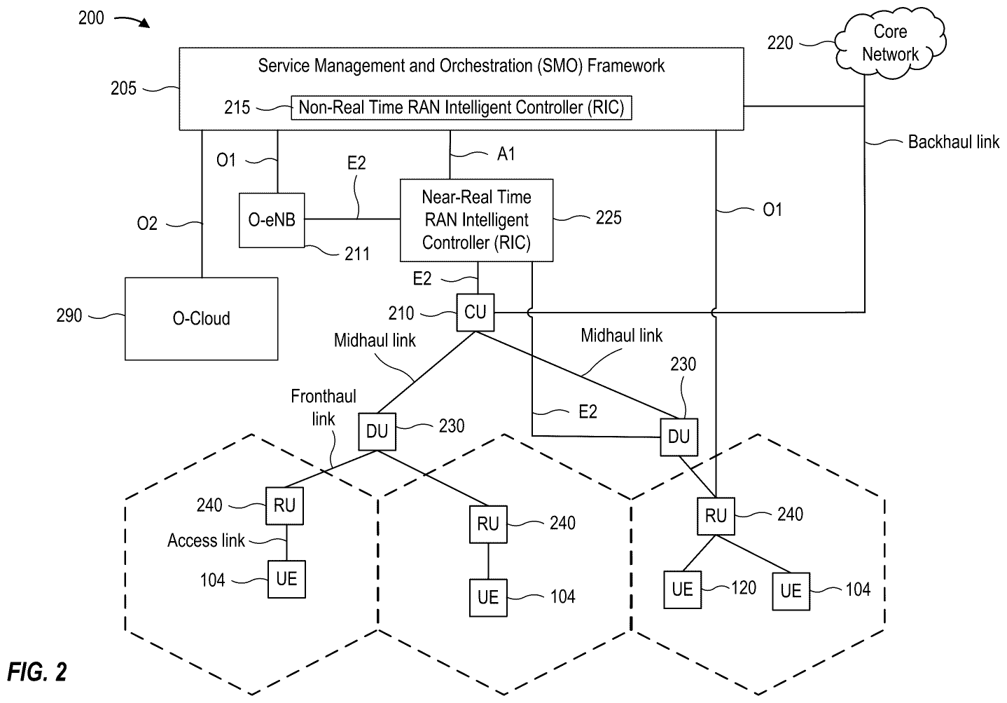

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

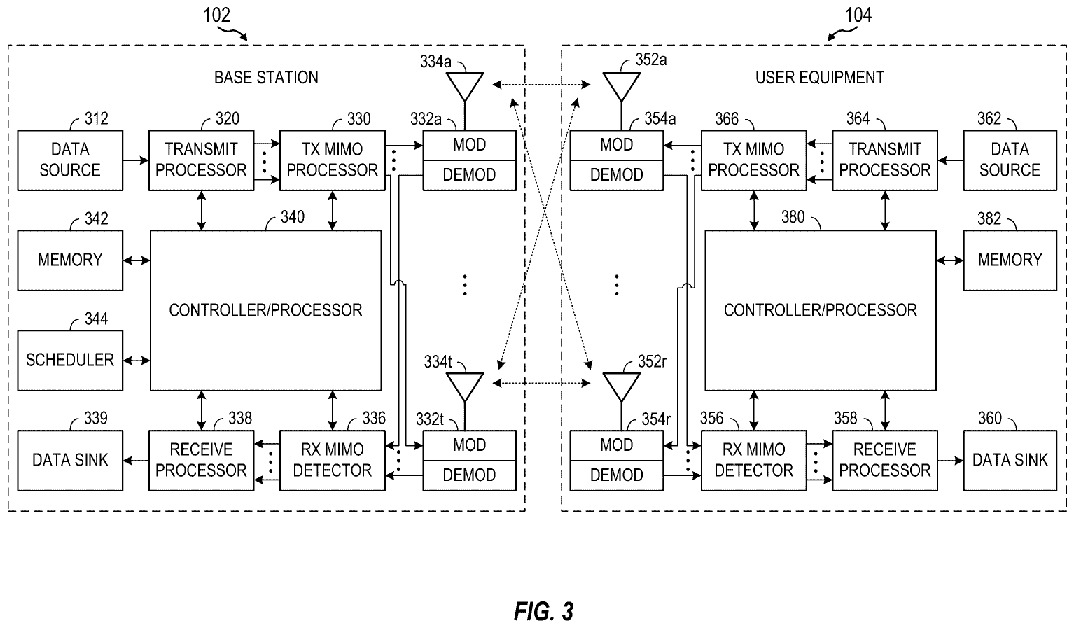

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

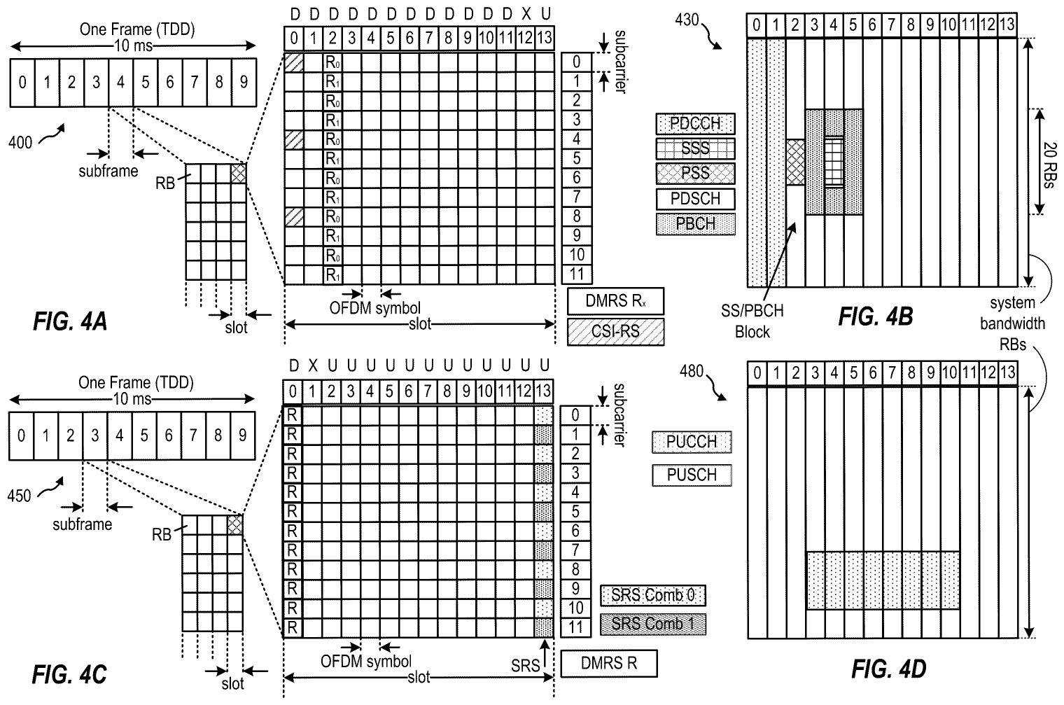

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (u) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Handover Procedures

HO procedures are generally designed to provide seamless/lossless data to a UE, allowing the UE to maintain adequate signal quality while moving across multiple cells.

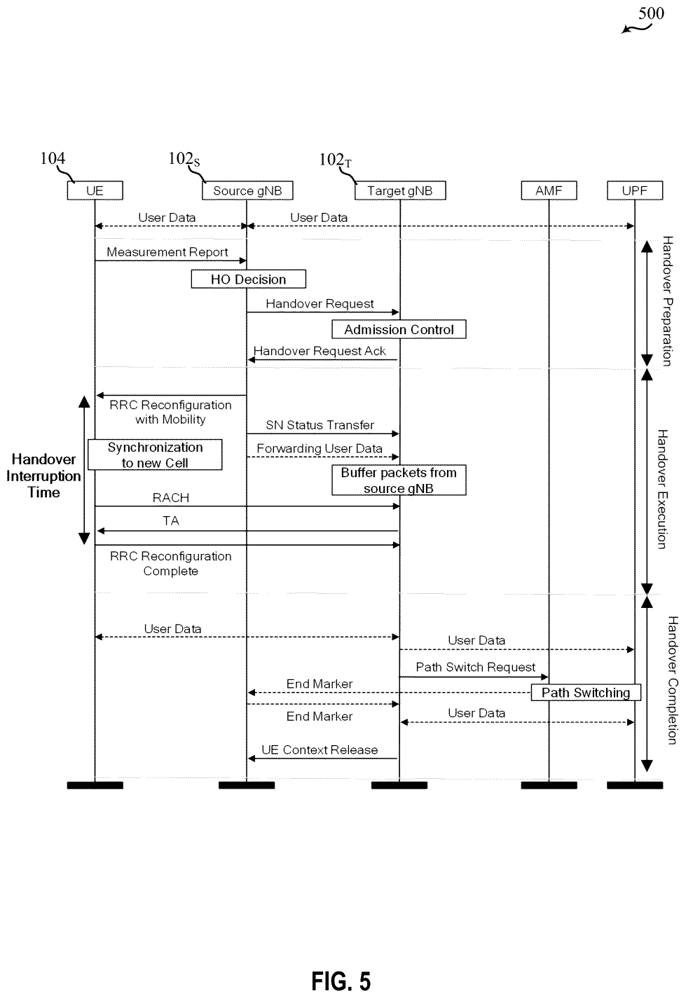

FIG. 5 depicts a call flow diagram 500 for a conventional HO procedure to handover a UE 104 from a (source gNB 102s) of a source cell to a (target gNB 102T) of a target cell.

As illustrated, the HO procedure generally includes an HO preparation phase and an HO execution phase. During the handover preparation phase, the source gNB may obtain UE measurements in order to determine if handover should be initiated. If a HO decision is made, the preparation may also include preparing the resources in the target cell RAT and core network side. During the HO execution phase, the source gNB sends an HO message/command via an RRC reconfiguration with Mobility message, directing the UE to the target gNB. The HO message prompts the UE to synchronize with the target cell, for example, performing a RACH procedure.

During the HO procedure, uplink and/or downlink user data may be buffered and then forwarded according to a most appropriate path (e.g., determined by the specific process/handover type itself) in an effort in an effort to minimize the loss of user data. As illustrated, data delivery may be interrupted for a time while the HO is executed.

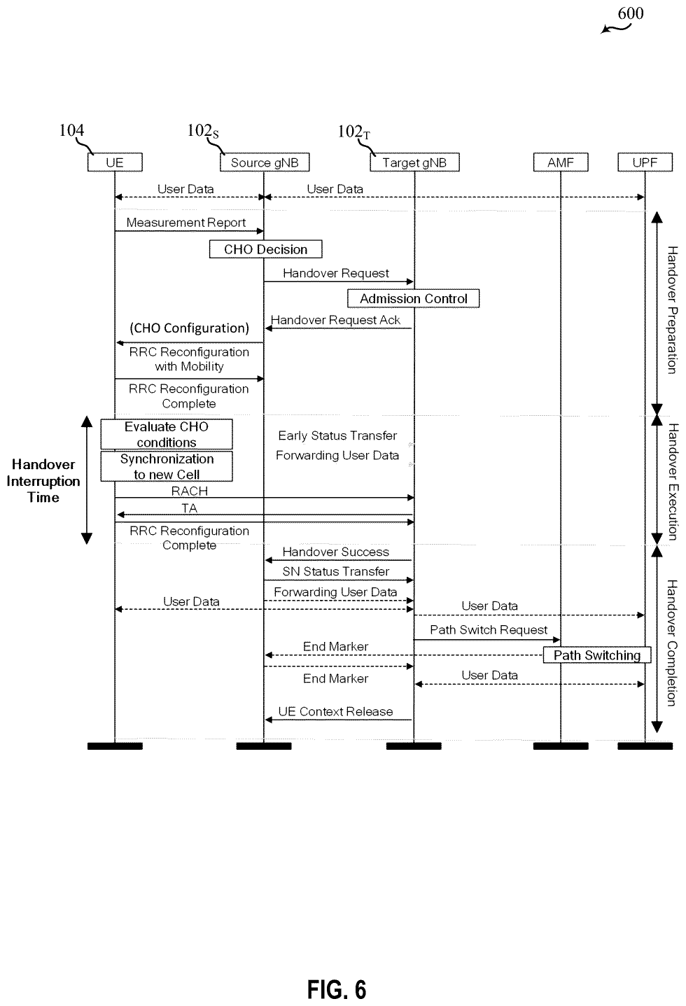

FIG. 6 depicts a call flow diagram 600 for a conditional handover (CHO) procedure.

As illustrated, for a CHO, the source gNB may sends the handover message earlier and keep transmitting packets until it receives a handover success message from the target gNB.

Via a CHO RRC configuration, the source gNB can (pre) configure the UE to initiate a handover when a certain measurement condition is met. For example, the condition may be based on some type of reference signal received power (RSRP) or reference signal received quality (RSRQ) measurement. For example, the condition may dictate that if (the RSRP of) the neighbor cell becomes 3 dB better than the source cell, the UE autonomously executes the handover without the need for any extra RRC messages.

As illustrated, data delivery may be interrupted for a time while the HO is executed, for example, while the UE evaluates the CHO condition(s) and synchronizes to the target cell.

### Aspects Related to Enhanced Handover for PDU Set Level QoS Handling

Aspects of the present disclosure relate to wireless communications, and more particularly, to techniques for handing a wireless device from one cell to another, in a manner that considers quality of service (QOS) parameters of protocol data unit (PDU) sets.

5G new radio (NR) provides a high-speed, low-latency and high-reliability wireless connectivity which can enable immersive virtual reality (VR), augmented reality (AR) and extended reality (XR) multimedia and cloud computing services. XR/multimedia data services may involve various user interface (UI) devices.

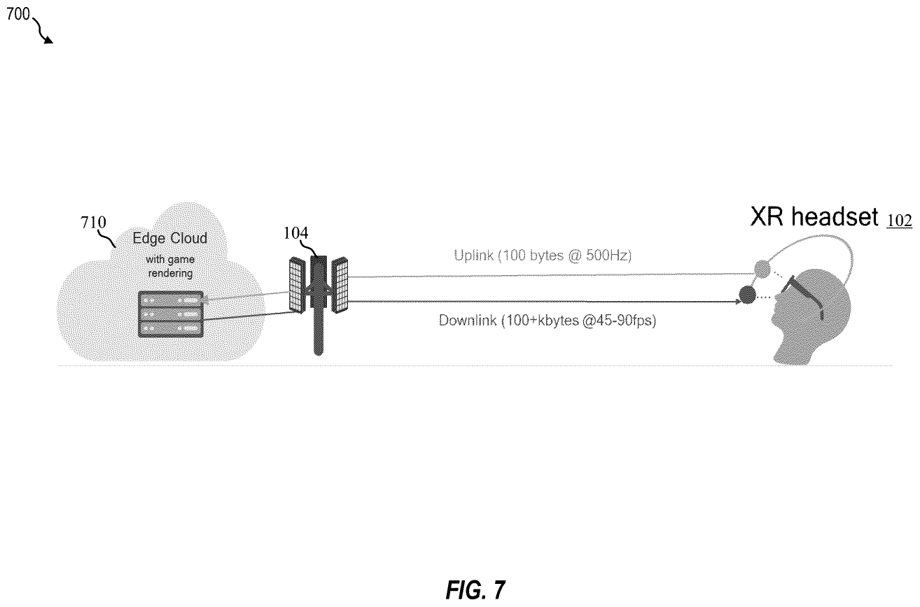

For example, diagram 700 of FIG. 7 depicts a scenario where a UE, such as an XR headset, AR Glasses and VR Head-Mounted Displays (HMDs) is used to communicate with an edge cloud 710 for Cloud-based Gaming and Cloud-based artificial intelligence (AI).

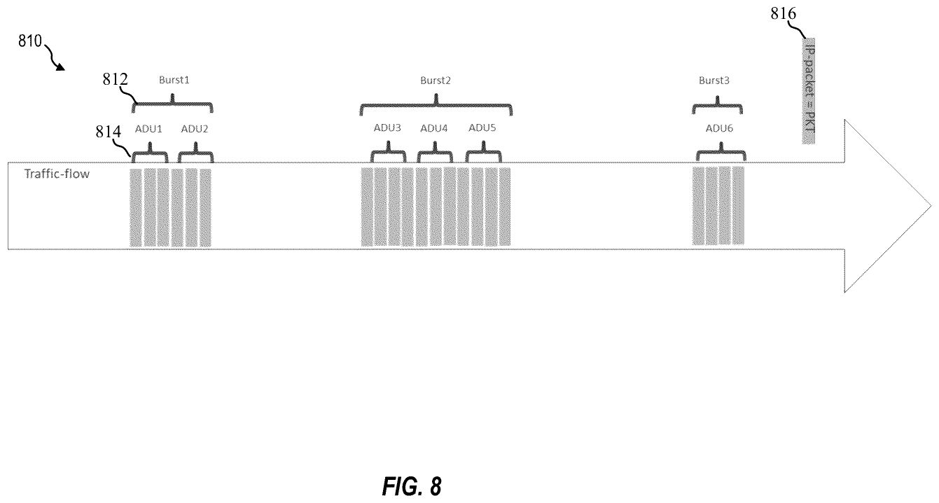

As illustrated in FIG. 8, a traffic flow 810 of XR applications may include bursts 812 of protocol data unit (PDU) sets 814, which may also be referred to as an application data unit (ADU). Each PDU set may represent a set of Internet Protocol (IP) packets 816 that represents a unit of information at an application layer, such as one video frame per burst or “slices” of a video frame per burst. A burst 812 generally refers to a set of PDU sets 814 that include IP packets 816 that should be delivered to a user equipment (UE) with the same deadline (e.g., all slices of a video frame).

XR applications often consume data in relatively large units, referred to as protocol data unit (PDU) sets that represent a set of Internet Protocol (IP) packets, rather than single IP packets. In both uplink and downlink, certain features may rely on the notions of PDU Set and Data Burst. PDU sets and Data Bursts generally enable a radio access network (RAN) to identify the PDUs which carry content that the application processes as a single unit (e.g., an application data unit/ADU that represents a portion of an image, an audio frame) and the duration of a data transmission, respectively. A Data Burst may include different PDU sets that should be delivered to a user equipment (UE) with the same deadline (e.g., all slices of a video frame).

As noted above, applications may specify transport layer requirements on a PDU Set, for example, that PDU sets should be delivered within a certain timeframe, referred to as a PDU set delay budget (PSDB).

One potential challenge in meeting specified PSDBs when delivering PDU sets is the occurrence of handover (HO) procedures. For example, as described above with reference to FIGS. 5 and 6, during an HO from a source cell to a target cell, data delivery to the UE may be interrupted. If a HO occurs during (in the middle of) a PDU set transmission, it may be difficult to meet the specified PSDB due to the HO interruption time.

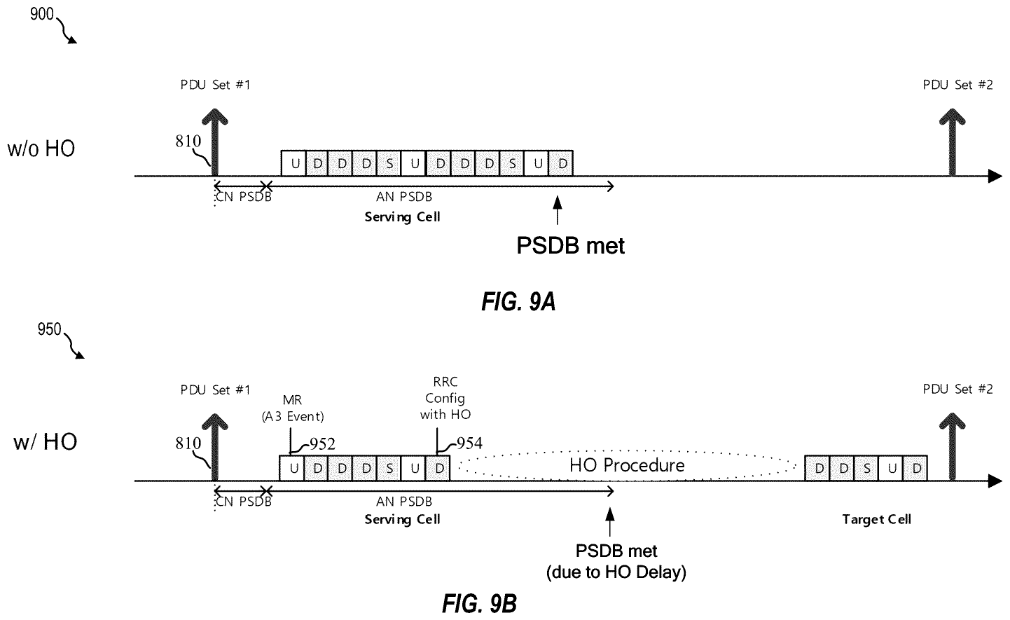

The impact of an HO procedure on meeting a PSDB may be understood with reference to diagrams 900 and 950 of FIGS. 9A and 9B, that respectively.

Referring first to FIG. 9A, a first PDU set 810 arrives at a core network (CN) and is expected to be delivered to a radio access network (RAN)/source gNB within a CN PSDB. The PDU set is expected to be delivered from the source gNB to the UE with an access network (AN) PSDB. In the example illustrated in FIG. 9A, there is no handover to interrupt delivery of the PDU set 810 and the AN PSDB is met.

In the example illustrated in FIG. 9B, however, a HO occurs during PDU set transmission. As shown at 952, based on a measurement report (MR) from a UE (e.g., indicating an A3 event, meaning a neighboring cell becomes better than the serving cell by an offset), the source cell initiates the handover by sending the HO message (RRC configuration with HO), as indicated at 954.

As noted above, during the HO procedure, data transmission will be prevented (during the handover interruption time illustrated in FIGS. 5 and 6). Because the HO occurred before all packets of the PDU set were delivered, in this example, the PSDB of the PDU Set is not met.

Aspects of the present disclosure, however, provide enhanced HO mechanisms that may be designed to help satisfy PDU-set level delivery requirements during mobility. By helping satisfy QoS parameters of PDU sets, while supporting mobility of a UE between cells, aspects of the present disclosure may improve system performance and enhance overall user experience.

According to certain aspects, if a HO occurs during delivery of a PDU set, a network entity (e.g., a gNB) of a source cell may perform at least one action to delay handover of the UE to a target cell until completion of delivery of PDU set to the UE.

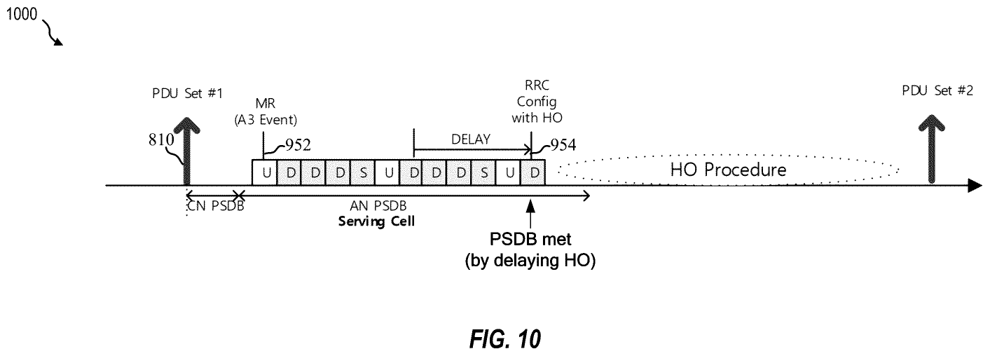

For example, as illustrated in diagram 1000 of FIG. 10, if an HO occurs during delivery of a PDU set, a source gNB may delay sending an HO message 954 until completion of delivery of a PDU set. As a result of delaying the HO message 954 in this manner, delivery of the current PDU Set #1 may be ensured and the PDSB is met.

According to certain aspects, a QoS parameter may indicate (request) this type of PDU Set-level HO behavior. As an example, a QoS parameter from an application function (AF) or point coordination function (PCF) may indicate that, for a certain type of traffic flow, this type of PDU set level HO should be enabled.

One potential challenge with delaying an HO message until completion of PDU set delivery is that there is a chance that each DL packet may have an error. As a result, the source cell may need to wait for hybrid automatic repeat request (HARQ) feedback for each PDU of the PDU Set before it can schedule HO message.

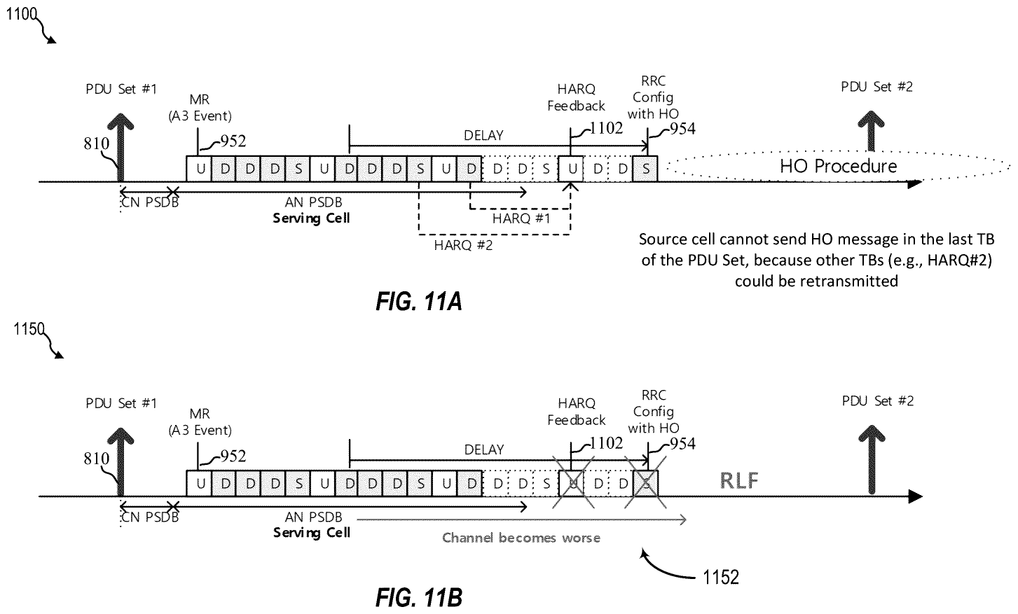

For example, in the diagram 1100 of FIG. 11A, the source cell is unable to send the HO message in the last transport block (TB) of the PDU Set, because other TBs (e.g., corresponding to HARQ #2) may need to be retransmitted. The combination of the time for HARQ feedback 1102 plus scheduling latency of a delayed HO message may further delay HO to a better cell, which may adversely impact performance.

Further, since UE feedback is typically limited, a gNB may not be able to know the channel condition of the UE for every slot. There is, thus, some risk to delaying the handover message until the PDU Set is completely delivered that channel conditions may deteriorate.

For example, as illustrated in diagram 1150 of FIG. 11B, if the source cell delays the HO message, the channel conditions may become bad during the delayed period. As a result of the bad channel conditions, deliver of HARQ feedback 1102 and/or HO message 954 may fail and a radio link failure (RLF) may occur.

For these reasons, it may be better to leave the handover triggering decision to the UE, by configuring the UE for CHO. According to certain aspects of the present disclosure, in such cases, a UE may delay performing a handover, conditional upon completion of delivery of a PDU set.

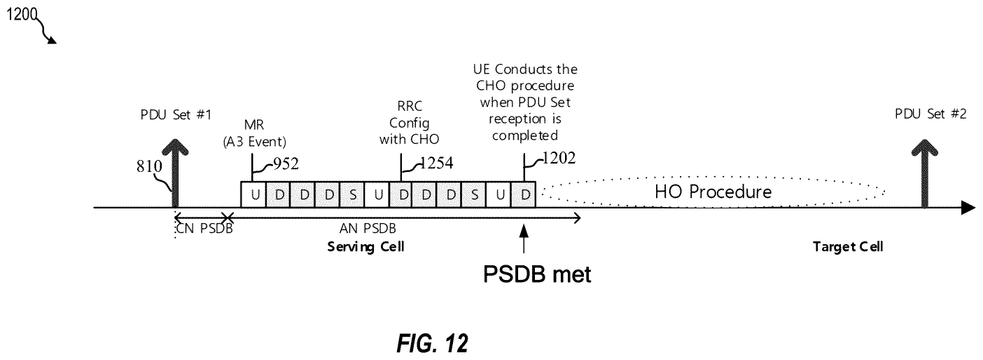

Diagram 1200 of FIG. 12 illustrates one example of such a conditional HO with PDU set delivery in mind. In this example, after the MR indicating an A3 event, the source gNB configures the UE for CHO via RRC Configuration with CHO message 1254. For example, the CHO message 1254 may configure the UE to activate the CHO conditional upon PDU Set delivery completion, as indicated at 1202.

In other words, a CHO condition may be PDU Set delivery completion. By configuring the UE in this manner, the PSDB may be met before conducting the CHO procedure.

One potential advantage to this approach is that the network may simply send the HO (CHO) message to UE as per conventional CHO procedures. Once UE receives the last transmission of PDU Set (or burst), the UE may conduct the HO procedure. If a TB error happens, the UE may be able to keep its connection with the source cell until delivery of the PDB set is complete. Further, if channel conditions allow, the UE may be able to complete uplink traffic transmission (e.g., of its delay-critical data flows).

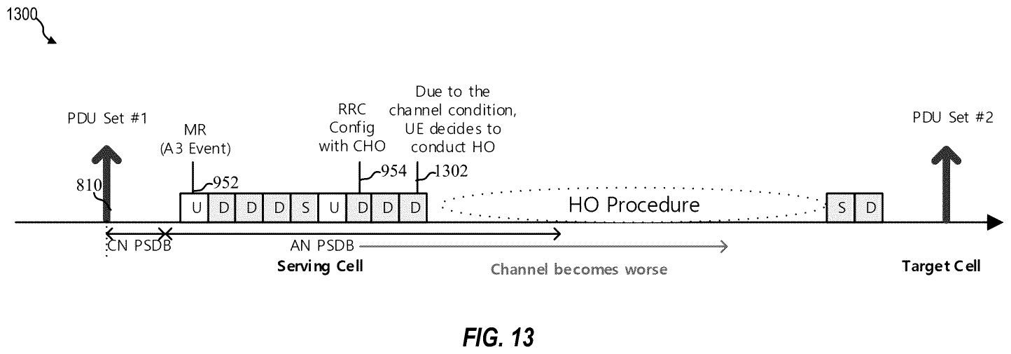

According to certain aspects, a UE may be able to conduct the HO procedure before delivery of the PDB set is complete under certain conditions. For example, as illustrated diagram 1300 of FIG. 13, a UE may be configured with such a mechanism to prevent the RLF when an HO procedure is delayed for PDU Set delivery.

As indicated at 1302 in the illustrated example, the UE may be configured to conduct the HO procedure, even before completion of delivery of the PDU Set if channel conditions deteriorate. This may be more tolerable to fail to meet a PSDB than to experience an RLF that may lead to lengthy delays.

There are various options for how a UE may be configured to implement such a mechanism. According to a first option, the UE may be configured to autonomously decide what channel condition should trigger the UE to conduct the HO during PDU set delivery. According to a second option, the source gNB may be able to specify what type of channel condition should trigger the UE to conduct the HO during PDU set delivery. For example, the source gNB may specify the UE should conduct the HO when a channel condition with the source cell becomes worse than a (specified) threshold.

According to certain aspects, an enhanced RRC CHO message may be introduced that has the HO triggering condition of PDU Set reception completion.

Such a CHO message may be sent in advance, but may only be activated when a certain PDU Set reception is completed. For an HO that involves a RACH procedure (e.g., a legacy HO), one additional condition of the CHO may be based on RACH occasion (RO) timing of the target cell. For example, if there is some time before a next RO, the UE may be better off staying in the source cell due to the delay. On the other hand, for certain types of HO, such as a lower layer triggered mobility (LTM), there is no RACH procedure, so the UE does not need to wait for the RACH occasion of the target cell.

As illustrated in FIG. 8 described above, there may be many PDU Sets in a burst. It may be beneficial for a UE to identify a specific PDU Set as a conditional HO trigger. There are various options for how a UE may identify a specific PDU set. According to a first option, a gNB may provide an explicit indication, for example, specifying the specific flow of a PDU Set, and the UE may conduct the HO right after the specific PDU Set is completely delivered. According to a second option, a PDU set may be identified by an End of Burst (EoB), for example, if there is such signaling from a gNB to the UE. According to a third option, a PDU set may be (explicitly) indicated via signaling such as a downlink control information (DCI) or medium access control (MAC) control element (CE) to indicate the end of traffic (e.g., end of PDU Set or end of Burst). According to a fourth option, end of traffic may be implied, for example, when the UE can enter a particular mode, such as a physical downlink control channel (PDCCH) skipping state or sleep mode (inactive state).

According to certain aspects, a UE may be configured to initiate an HO procedure (e.g., beginning with sending a RACH to the target cell) once it receives the last transmission of a PDU Set (or burst of PDU sets). As an alternative (or in addition), a UE may be configured to initiate the HO procedure when it enters enter a sleep mode or send a Packet Data Convergence Protocol (PDCP) status report for a PDU Set.

As noted above, in some cases, a UE may decide to complete the uplink transmission of time-critical uplink flows before conducting an HO procedure. In such cases, there are various options for how the UE may be able to confirm the uplink transmission delivery. According to a first option, the UE may wait for a HARQ round trip time (RTT) after the last PDU. According to a second option, a UE may be configured to conduct the HO procedure based on a timer (after expiration), which may be configured in an enhanced CHO message. According to a third option, a UE may be configured to conduct the HO procedure when it estimates that the uplink will be delivered with a high probability (e.g., based on channel conditions or other metrics). Other options are also possible, depending on a particular UE implementation.

As noted above, in certain cases, a UE may be configured to initiate the HO even before PDU set delivery completion (conduct an early handover). As an example, if UE is not in a good condition (as in the example shown in FIG. 13), the UE may conduct the HO during the PDU Set transmission period. According to one option, the UE may be configured to autonomously decide whether it should conduct early handover or not. According to another option, the source cell may indicate a specific channel condition for early handover. For example, the source cell can provide the UE with a threshold of the instantaneous handover (e.g., based on RSRP, RSRQ). In some cases, the UE may decide on HO triggering without feedback to the gNB.

According to certain aspects, a timer may be used to trigger CHO handover. For example, the UE may be configured to immediately trigger HO when this timer expires, for example, by which immediately indicates the HO when it expired. This may help address scenarios where the PDU Set delivery could be delayed too long due to retransmission or link condition. When this timer is expired, the UE may immediately conduct the handover to the target cell, regardless of PDU Set delivery status. The timer value may be set according to the PDU Set delivery HO (e.g., less than a PSDB).

As illustrated in FIGS. 5 and 6, as part of HO completion, a user plane function (UPF) may switch a data path from the source cell to the target cell. In some cases, the UPF may switch the path according to a PDU Set level granularity (not IP packet level granularity). In such cases, the source cell may indicate the current PDU Set index to UPF or the target cell. This may help avoid duplicated PDCP packet delivery at the target cell.

In the case of early handover, the source cell may forward the remaining PDUs to the target cell. For PDU Set delivery based HO, the handover related message (e.g., Path Switch, End Marker, SN Status Transfer) may be enhanced for such PDU Set level granularity. For example, if the source sends the enhanced path switch message, the path may be switched from the source cell to the target cell from the next PDU Set.

According to certain aspects of the present disclosure, it may be beneficial to inform the target cell of a remaining PSDB after a handover. For example, assuming that an HO is triggered during the PDU Set delivery at the source cell, it is still desirable for the PDU set to be meet the specified PSDB. However, the target cell would not normally be aware of the remaining PSDB of the source cell. In certain cases, for a dual active protocol stack (DAPS) or LTM HO, the target cell may still be able to meet the PSDB of the PDU Set after the HO.

According to certain aspects, if an HO happens during PDU Set delivery, the source cell may deliver the remaining PSDB budget of PDU Set to the target cell. The remaining PSDB budget may be delivered, for example, with a PDCP SN Status Transfer, with forwarded PDCP packets, with any existing Xn message related to handover, or deliver via a newly defined message. Delivery of remaining PSDB budget of a PDU Set may be applicable to any type of HO protocol, such as a normal HO (per FIG. 5), CHO (per FIG. 6), DAPS HO, or LTM HO.

According to certain aspects, instead of an implicit indication (PDU Set delivery completion), a gNB may send an explicit signal to initiate a preconfigured HO. This type of signaling may also be extended to any type of HO protocol. As described above, a gNB can send an RRC HO message earlier to UE and a UE can trigger the HO (e.g., if the channel conditions become poor).

An HO may be triggered by various types of signaling. For example, an HO may be triggered by a PDCCH with an HO offset or by a MAC-CE. In some cases, a gNB may send a new type of DCI or MAC-CE which indicates when the HO should be triggered via an offset value.

In some cases, an HO may be triggered by the UE entering a PDCCH skipping mode or a DRX inactive state. In other words, when the UE enters the state of PDCCH skipping or DRX inactive state, the HO may be automatically triggered. Thus, HO occurs after PDCCH skipping starts (e.g., after receiving a PDCCH skipping command from the gNB). In some cases, an HO may be triggered when the last HARQ ACK feedback is delivered. The HO may be triggered without forward error correction (FEC) where the last HARQ ACK feedback for the last TB transmission for PDU Set (including retransmission). The HO may be triggered with FEC, based on the last HARQ ACK feedback when enough number of PDUs of a PDU Set are delivered.

In some cases, an enhanced RRC HO message may specify the handover timing (e.g., End of PDU Set delivery). In some cases, the source gNB may conduct the handover preparation (e.g., HO Request, HO Request Ack) with the target cell. In some cases, the enhanced HO message may be sent to the UE earlier than the actual timing of handover initiation. The enhanced HO message may allow that UE to trigger the HO while waiting for PDU Set delivery completion (e.g., based on bad channel condition). In some cases, the target gNB may notify the source gNB when it receives a RACH or an RRC configuration complete message. In such cases, the source gNB may forward the remaining PDUs to the target cell, if necessary.

In some cases, the source gNB may starts the handover execution (e.g., SN Status Transfer, Forwarding User Data) after a current PDU Set is completely delivered or when the target gNB notifies the source gNB. In some cases, the UE may conducts the handover procedure (e.g., transmitting RACH to the target cell) after the current PDU Set is completely delivered.

The enhanced HO mechanisms proposed herein may be implemented as an option under current specifications with little or no change. This may be possible because standards may roughly define handover timing (e.g., based on RSRP, RSRQ, RSSI), without specify the slot-level timing, which may allow a UE to decide the exact handover timing.

In some cases, the enhanced HO mechanisms proposed herein may be implemented even without explicit signaling of an HO message with PDU Set delivery, and a UE may delay the handover procedure until it completely receives the current PDU Set or burst. In some cases, if the UE estimates that the channel condition allows delaying HO, the UE may postpone the handover procedure. The UE may initiate the handover whenever the channel condition becomes bad. The UE may delay the HO procedure until the current PDU Set is completely delivered or until the next RACH occasion of the target cell.

In other cases, a UE may conduct the handover earlier when it completely receives the current PDU Set or burst. For example, this may assume that the HO channel condition is not exactly met yet, but that the PDU Set is completed delivered. If the UE estimates that it would be better to conduct the handover before the next PDU Set delivery, the UE may conduct the handover procedure. In some cases, some allowed channel condition margin may be defined in the implementation. For example, 1 dB margin may be allowed for PDU Set delivery. In an HO message, a gNB may indicate that the UE can conduct the handover when a first gNB (e.g., gNB #1) becomes 3 dB better than a second gNB (e.g., gNB #2). A UE can conduct the early handover even from the time when the first gNB becomes 2 dB better than the second gNB. In some cases, such a parameter may be defined in a standard specification.

In some cases, in a CU-DU split architecture (e.g., per FIG. 2), a DU may not be able to identify whether a PDCP packet includes a handover message. In other words, for some handover cases, the DU may not be able to know whether the CU has made a decision regarding the handover or not. In such cases, a PDCP control packet may be ciphered by the CU, but the DU may not be able to de-cipher the PDCP control packet to identify the handover signaling. (e.g., an RRC Container for handover may be ciphered). For some handover cases, the handover message may not be explicitly indicated over F1 interface.

To address such scenarios, in some cases, a CU may explicitly indicate to the DU that a current PDPC control packet has a handover message (e.g., RRCReconfiguration) over the F1 interface, and the DU may then utilize the PDPC control packet for a handover with PDU Set-level QoS handling. According to one option, the indication may be provided via an enhanced F1 protocol (e.g., F1 AP). According to another option, the indication may be provided via a General Packet Radio Service (GPRS) tunneling protocol (e.g., GTP-C).

For some purposes (e.g., early data forwarding from a source cell to a target cell), a system may be able to share the information of a PDU Set index to explicitly identify when the handover will be activated. According to certain aspects, such a system may share a PDU Set index for the handover with PDU Set-level QoS handling. For example, the delivery stations (PDU Set Index) may be shared via a CU-UP←→CU-CP (E1-interface), CU←→DU (F1 interface), and/or a gNB to UE (uu interface) may indicate the explicit handover timing with a certain PDU Set index. For example, when a certain PDU Set is completely delivered, the handover may be activated.

In some cases, in a CHO message, the source cell may indicate whether each candidate target cell is capable of handling a PDU Set or not. For an XR application, it may be better to conduct the handover to a target cell which is capable of handling the PDU Set. However, there is currently no way for UE to know if the candidate target cell can handle the PDU Set or not. In a CHO message, the source cell may indicate whether each candidate target cell is capable of handling PDU Set or not. In such cases, a UE may consider the capability of PDU Set handling when deciding the target cell. Even if a handover condition is met, the UE may not conduct the handover to a target cell which cannot handle PDU Set. In some cases, if the channel condition with the source cell allows, the UE may wait for the handover condition to be met for a target cell which can handle PDU Set.

In some cases, a UE capability may indicate if the UE can conduct the type of enhanced HO for PDU Set proposed herein. In such cases, a gNB may send an “enhanced HO for PDU Set” only to the UEs which have indicated that they have the capability for that type of HO.

### Example Operations

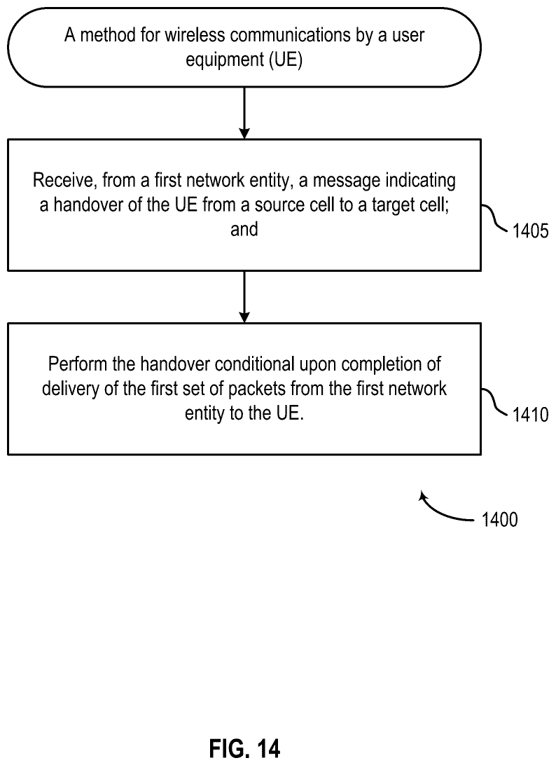

FIG. 14 shows an example of a method 1400 of wireless communications by a user equipment (UE), such as a UE 104 of FIGS. 1 and 3.

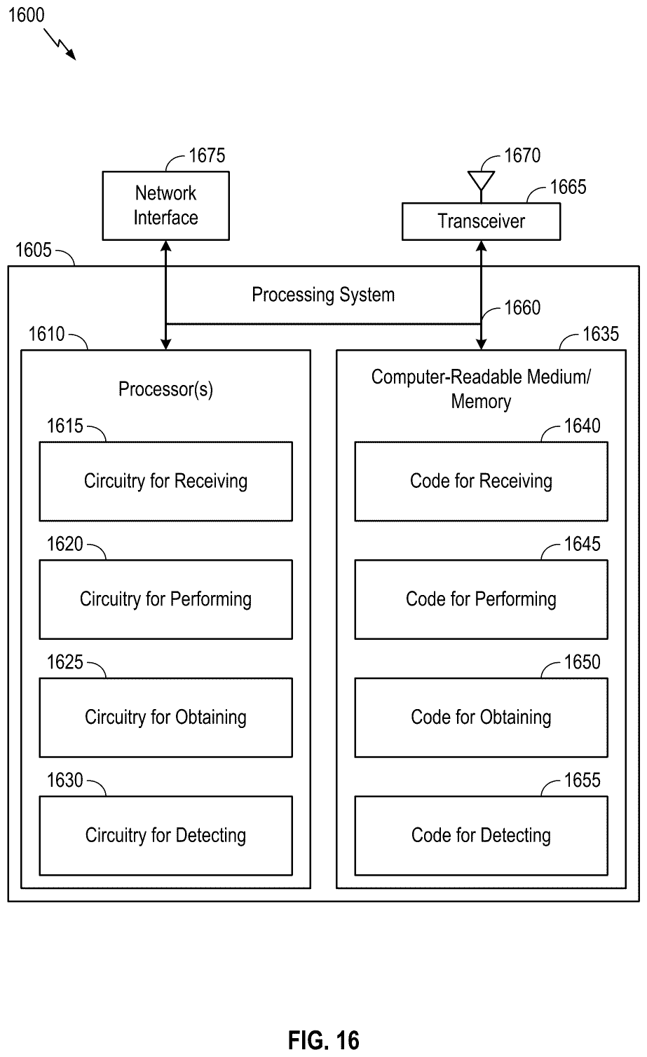

Method 1400 begins at step 1405 with receiving, from a first network entity, a message indicating a handover of the UE from a source cell to a target cell. In some cases, the operations of this step refer to, or may be performed by, circuitry for receiving and/or code for receiving as described with reference to FIG. 16.

Method 1400 then proceeds to step 1410 with performing the handover conditional upon completion of delivery of the first set of packets from the first network entity to the UE. In some cases, the operations of this step refer to, or may be performed by, circuitry for performing and/or code for performing as described with reference to FIG. 16.

In some aspects, the first set of packets comprises a set of internet protocol (IP) packets representing a unit of information at an application layer.

In some aspects, the message comprises a conditional handover message that indicates the UE can perform the handover conditional upon completion of delivery of the first set of packets to the UE.

In some aspects, the handover is also conditional on random access channel (RACH) occasion (RO) timing of the target cell.

In some aspects, the conditional handover message identifies at least one of: the first set of packets; or a burst of sets of packets that includes the first set of packets.

In some aspects, the handover is also conditioned on at least one of: the UE receiving signaling from the first network entity indicating an end of traffic; or the UE entering at least one of a physical downlink control channel (PDCCH) skipping mode or a sleep mode.

In some aspects, the handover is also conditioned on completion of at least one uplink transmission from the UE to the first network entity.

In some aspects, the message also indicates the UE can perform the conditional handover prior to completion of delivery of the first set of packets to the UE, based upon at least one of: expiration of a timer; or a channel condition threshold.

In some aspects, the message is received via at least one of a physical downlink control channel (PDCCH) or medium access control (MAC) control element (CE) that indicates when the handover should be triggered.

In some aspects, the message indicates that timing of the handover is dependent on delivery of the first set of packets to the UE.

In some aspects, performing the handover comprises delaying the handover based on at least one of: channel conditions; incomplete delivery of the first set of packets to the UE; or random access channel (RACH) occasion (RO) timing of the target cell.

In some aspects, performing the handover comprises performing the handover: after completion of delivery of the first set of packets to the UE, in order to receive a second set of packets in the source cell.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

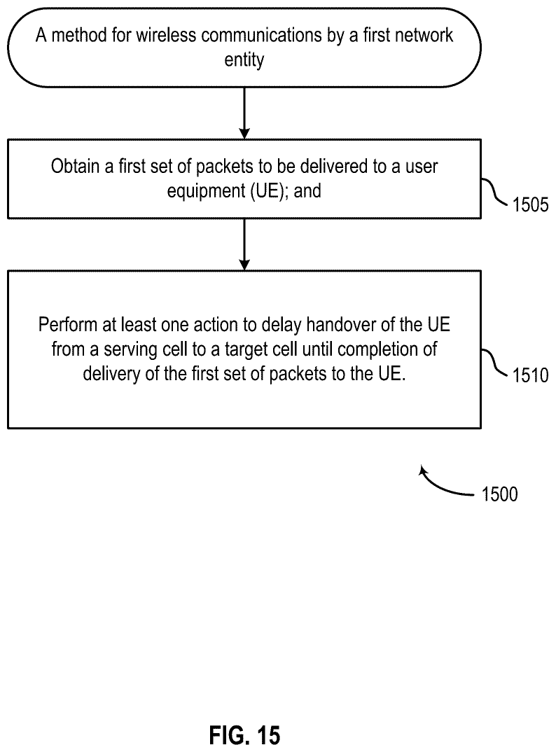

FIG. 15 shows an example of a method 1500 of wireless communications by a first network entity, such as a BS 102 of FIGS. 1 and 3, or a disaggregated base station as discussed with respect to FIG. 2.

Method 1500 begins at step 1505 with obtaining a first set of packets to be delivered to a user equipment (UE). In some cases, the operations of this step refer to, or may be performed by, circuitry for obtaining and/or code for obtaining as described with reference to FIG. 16.

Method 1500 then proceeds to step 1510 with performing at least one action to delay handover of the UE from a serving cell to a target cell until completion of delivery of the first set of packets to the UE. In some cases, the operations of this step refer to, or may be performed by, circuitry for performing and/or code for performing as described with reference to FIG. 16.

In some aspects, the first set of packets comprises a set of internet protocol (IP) packets representing a unit of information at an application layer.

In some aspects, the method 1500 further includes detecting a condition to trigger handover of UE from a serving cell to a target cell. In some cases, the operations of this step refer to, or may be performed by, circuitry for detecting and/or code for detecting as described with reference to FIG. 16.

In some aspects, the at least one action comprises delaying transmission of a handover message, after detecting the condition, until after completion of delivery of the first set of packets to the UE.

In some aspects, the method 1500 further includes obtaining a quality of service (QOS) parameter indicating timing of transmission of the message should be dependent on delivery of the first set of packets to the UE. In some cases, the operations of this step refer to, or may be performed by, circuitry for obtaining and/or code for obtaining as described with reference to FIG. 16.

In some aspects, the at least one action comprises transmitting a message for a conditional handover, wherein the message indicates the UE can perform the handover conditional upon completion of delivery of the first set of packets to the UE.

In some aspects, the conditional handover message is transmitted prior to detecting a condition to trigger handover of UE from a serving cell to a target cell.

In some aspects, the handover is also conditioned on random access channel (RACH) occasion (RO) timing of the target cell.

In some aspects, the conditional handover message identifies at least one of: the first set of packets; or a burst of sets of packets that includes the first set of packets.

In some aspects, the handover is also conditioned on at least one of: the UE receiving signaling from the first network entity indicating an end of traffic; or the UE entering at least one of a physical downlink control channel (PDCCH) skipping mode or a sleep mode.

In some aspects, the handover is also conditioned on completion of at least one uplink transmission from the UE to the first network entity.

In some aspects, the message also indicates the UE can perform the conditional handover prior to completion of delivery of the first set of packets to the UE, based upon at least one of: expiration of a timer; or a channel condition threshold.

In some aspects, the first set of packets has a delay budget; and the method further comprising transmitting an indication of a remainder of the delay budget to a second network entity of the target cell, if the handover occurs prior to completion of delivery of the first set of packets to the UE.

In some aspects, the at least one action comprises transmitting at least one of a physical downlink control channel (PDCCH) or medium access control (MAC) control element (CE) that indicates when the handover should be triggered.

In some aspects, the at least one action comprises transmitting a handover message that indicates handover timing dependent on delivery of the first set of packets to the UE; and the method further comprises participating in handover preparation with a second network entity of the target cell after transmitting the handover message.

In one aspect, method 1500, or any aspect related to it, may be performed by an apparatus, such as communications device 1600 of FIG. 16, which includes various components operable, configured, or adapted to perform the method 1500. Communications device 1600 is described below in further detail.

Note that FIG. 15 is just one example of a method, and other methods including fewer, additional, or alternative steps are possible consistent with this disclosure.

### Example Communications Device(s)

FIG. 16 depicts aspects of an example communications device 1600. In some aspects, communications device 1600 is a user equipment, such as UE 104 described above with respect to FIGS. 1 and 3. In some aspects, communications device 1600 is a network entity, such as BS 102 of FIGS. 1 and 3, or a disaggregated base station as discussed with respect to FIG. 2.

The communications device 1600 includes a processing system 1605 coupled to the transceiver 1665 (e.g., a transmitter and/or a receiver). In some aspects (e.g., when communications device 1600 is a network entity), processing system 1605 may be coupled to a network interface 1675 that is configured to obtain and send signals for the communications device 1600 via communication link(s), such as a backhaul link, midhaul link, and/or fronthaul link as described herein, such as with respect to FIG. 2. The transceiver 1665 is configured to transmit and receive signals for the communications device 1600 via the antenna 1670, such as the various signals as described herein. The processing system 1605 may be configured to perform processing functions for the communications device 1600, including processing signals received and/or to be transmitted by the communications device 1600.

The processing system 1605 includes one or more processors 1610. In various aspects, the one or more processors 1610 may be representative of one or more of receive processor 358, transmit processor 364, TX MIMO processor 366, and/or controller/processor 380, as described with respect to FIG. 3. In various aspects, one or more processors 1610 may be representative of one or more of receive processor 338, transmit processor 320, TX MIMO processor 330, and/or controller/processor 340, as described with respect to FIG. 3. The one or more processors 1610 are coupled to a computer-readable medium/memory 1635 via a bus 1660. In certain aspects, the computer-readable medium/memory 1635 is configured to store instructions (e.g., computer-executable code) that when executed by the one or more processors 1610, cause the one or more processors 1610 to perform the method 1400 described with respect to FIG. 14, or any aspect related to it; and the method 1500 described with respect to FIG. 15, or any aspect related to it. Note that reference to a processor performing a function of communications device 1600 may include one or more processors 1610 performing that function of communications device 1600.

In the depicted example, computer-readable medium/memory 1635 stores code (e.g., executable instructions), such as code for receiving 1640, code for performing 1645, code for obtaining 1650, and code for detecting 1655. Processing of the code for receiving 1640, code for performing 1645, code for obtaining 1650, and code for detecting 1655 may cause the communications device 1600 to perform the method 1400 described with respect to FIG. 14, or any aspect related to it; and the method 1500 described with respect to FIG. 15, or any aspect related to it.

The one or more processors 1610 include circuitry configured to implement (e.g., execute) the code stored in the computer-readable medium/memory 1635, including circuitry for receiving 1615, circuitry for performing 1620, circuitry for obtaining 1625, and circuitry for detecting 1630. Processing with circuitry for receiving 1615, circuitry for performing 1620, circuitry for obtaining 1625, and circuitry for detecting 1630 may cause the communications device 1600 to perform the method 1400 described with respect to FIG. 14, or any aspect related to it; and the method 1500 described with respect to FIG. 15, or any aspect related to it.

Various components of the communications device 1600 may provide means for performing the method 1400 described with respect to FIG. 14, or any aspect related to it; and the method 1500 described with respect to FIG. 15, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1665 and the antenna 1670 of the communications device 1600 in FIG. 16. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1665 and the antenna 1670 of the communications device 1600 in FIG. 16.

### Example Clauses

Implementation examples are described in the following numbered clauses:

Clause 1: A method for wireless communications by a user equipment (UE), comprising: receiving, from a first network entity, a message indicating a handover of the UE from a source cell to a target cell; and performing the handover conditional upon completion of delivery of the first set of packets from the first network entity to the UE.

Clause 2: The method of Clause 1, wherein the first set of packets comprises a set of internet protocol (IP) packets representing a unit of information at an application layer.

Clause 3: The method of any one of Clauses 1-2, wherein the message comprises a conditional handover message that indicates the UE can perform the handover conditional upon completion of delivery of the first set of packets to the UE.

Clause 4: The method of Clause 3, wherein the handover is also conditional on random access channel (RACH) occasion (RO) timing of the target cell.

Clause 5: The method of Clause 3, wherein the conditional handover message identifies at least one of: the first set of packets; or a burst of sets of packets that includes the first set of packets.

Clause 6: The method of Clause 3, wherein the handover is also conditioned on at least one of: the UE receiving signaling from the first network entity indicating an end of traffic; or the UE entering at least one of a physical downlink control channel (PDCCH) skipping mode or a sleep mode.

Clause 7: The method of Clause 3, wherein the handover is also conditioned on completion of at least one uplink transmission from the UE to the first network entity.

Clause 8: The method of Clause 3, wherein the message also indicates the UE can perform the conditional handover prior to completion of delivery of the first set of packets to the UE, based upon at least one of: expiration of a timer; or a channel condition threshold.

Clause 9: The method of any one of Clauses 1-8, wherein the message is received via at least one of a physical downlink control channel (PDCCH) or medium access control (MAC) control element (CE) that indicates when the handover should be triggered.

Clause 10: The method of any one of Clauses 1-9, wherein: the message indicates that timing of the handover is dependent on delivery of the first set of packets to the UE.

Clause 11: The method of any one of Clauses 1-10, wherein performing the handover comprises delaying the handover based on at least one of: channel conditions; incomplete delivery of the first set of packets to the UE; or random access channel (RACH) occasion (RO) timing of the target cell.

Clause 12: The method of any one of Clauses 1-11, wherein performing the handover comprises performing the handover: after completion of delivery of the first set of packets to the UE, in order to receive a second set of packets in the source cell.

Clause 13: A method for wireless communications by a first network entity, comprising: obtaining a first set of packets to be delivered to a user equipment (UE); and performing at least one action to delay handover of the UE from a serving cell to a target cell until completion of delivery of the first set of packets to the UE.

Clause 14: The method of Clause 13, wherein the first set of packets comprises a set of internet protocol (IP) packets representing a unit of information at an application layer.

Clause 15: The method of any one of Clauses 13-14, further comprising detecting a condition to trigger handover of UE from a serving cell to a target cell.

Clause 16: The method of Clause 15, wherein the at least one action comprises delaying transmission of a handover message, after detecting the condition, until after completion of delivery of the first set of packets to the UE.

Clause 17: The method of any one of Clauses 13-16, further comprising: obtaining a quality of service (QOS) parameter indicating timing of transmission of the message should be dependent on delivery of the first set of packets to the UE.

Clause 18: The method of any one of Clauses 13-17, wherein the at least one action comprises transmitting a message for a conditional handover, wherein the message indicates the UE can perform the handover conditional upon completion of delivery of the first set of packets to the UE.

Clause 19: The method of Clause 18, wherein the conditional handover message is transmitted prior to detecting a condition to trigger handover of UE from a serving cell to a target cell.

Clause 20: The method of Clause 18, wherein the handover is also conditioned on random access channel (RACH) occasion (RO) timing of the target cell.

Clause 21: The method of Clause 18, wherein the conditional handover message identifies at least one of: the first set of packets; or a burst of sets of packets that includes the first set of packets.

Clause 22: The method of Clause 18, wherein the handover is also conditioned on at least one of: the UE receiving signaling from the first network entity indicating an end of traffic; or the UE entering at least one of a physical downlink control channel (PDCCH) skipping mode or a sleep mode.

Clause 23: The method of Clause 18, wherein the handover is also conditioned on completion of at least one uplink transmission from the UE to the first network entity.

Clause 24: The method of Clause 18, wherein the message also indicates the UE can perform the conditional handover prior to completion of delivery of the first set of packets to the UE, based upon at least one of: expiration of a timer; or a channel condition threshold.

Clause 25: The method of any one of Clauses 13-24, wherein: the first set of packets has a delay budget; and the method further comprising transmitting an indication of a remainder of the delay budget to a second network entity of the target cell, if the handover occurs prior to completion of delivery of the first set of packets to the UE.

Clause 26: The method of any one of Clauses 13-25, wherein the at least one action comprises transmitting at least one of a physical downlink control channel (PDCCH) or medium access control (MAC) control element (CE) that indicates when the handover should be triggered.

Clause 27: The method of any one of Clauses 13-26, wherein: the at least one action comprises transmitting a handover message that indicates handover timing dependent on delivery of the first set of packets to the UE; and the method further comprises participating in handover preparation with a second network entity of the target cell after transmitting the handover message.

Clause 28: An apparatus, comprising: a memory comprising executable instructions; and a processor configured to execute the executable instructions and cause the apparatus to perform a method in accordance with any one of Clauses 1-27.

Clause 29: An apparatus, comprising means for performing a method in accordance with any one of Clauses 1-27.

Clause 30: A non-transitory computer-readable medium comprising executable instructions that, when executed by a processor of an apparatus, cause the apparatus to perform a method in accordance with any one of Clauses 1-27.

Clause 31: A computer program product embodied on a computer-readable storage medium comprising code for performing a method in accordance with any one of Clauses 1-27.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications by a user equipment (UE), comprising: at least one memory comprising computer-executable instructions; and one or more processors configured to execute the computer-executable instructions and cause the apparatus to:
receive, from a first network entity, a message indicating a handover of the UE from a source cell to a target cell; and
perform the handover conditional upon completion of delivery of the first set of packets from the first network entity to the UE.

2. The apparatus of claim 1, wherein the first set of packets comprises a set of internet protocol (IP) packets representing a unit of information at an application layer.

3. The apparatus of claim 1, wherein the message comprises a conditional handover message that indicates the UE can perform the handover conditional upon completion of delivery of the first set of packets to the UE.

4. The apparatus of claim 3, wherein the handover is also conditional on random access channel (RACH) occasion (RO) timing of the target cell.

5. The apparatus of claim 3, wherein the conditional handover message identifies at least one of:
the first set of packets; or
a burst of sets of packets that includes the first set of packets.

6. The apparatus of claim 3, wherein the handover is also conditioned on at least one of:
the UE receiving signaling from the first network entity indicating an end of traffic; or
the UE entering at least one of a physical downlink control channel (PDCCH) skipping mode or a sleep mode.

7. The apparatus of claim 3, wherein the handover is also conditioned on completion of at least one uplink transmission from the UE to the first network entity.

8. The apparatus of claim 3, wherein the message also indicates the UE can perform the conditional handover prior to completion of delivery of the first set of packets to the UE, based upon at least one of:
expiration of a timer; or
a channel condition threshold.

9. The apparatus of claim 1, wherein the message is received via at least one of a physical downlink control channel (PDCCH) or medium access control (MAC) control element (CE) that indicates when the handover should be triggered.

10. The apparatus of claim 1, wherein:
the message indicates that timing of the handover is dependent on delivery of the first set of packets to the UE.

11. The apparatus of claim 1, wherein performing the handover comprises delaying the handover based on at least one of:
channel conditions;
incomplete delivery of the first set of packets to the UE; or
random access channel (RACH) occasion (RO) timing of the target cell.

12. The apparatus of claim 1, wherein performing the handover comprises performing the handover:
after completion of delivery of the first set of packets to the UE, in order to receive a second set of packets in the source cell.

13. An apparatus for wireless communications by a first network entity, comprising: at least one memory comprising computer-executable instructions; and one or more processors configured to execute the computer-executable instructions and cause the apparatus to:
obtain a first set of packets to be delivered to a user equipment (UE); and
perform at least one action to delay handover of the UE from a serving cell to a target cell until completion of delivery of the first set of packets to the UE.

14. The apparatus of claim 13, wherein the first set of packets comprises a set of internet protocol (IP) packets representing a unit of information at an application layer.

15. The apparatus of claim 13, wherein the one or more processors are further configured to execute the computer-executable instructions and cause the apparatus to detect a condition to trigger handover of UE from a serving cell to a target cell.

16. The apparatus of claim 15, wherein the at least one action comprises delaying transmission of a handover message, after detecting the condition, until after completion of delivery of the first set of packets to the UE.

17. The apparatus of claim 13, wherein the one or more processors are further configured to execute the computer-executable instructions and cause the apparatus to:
obtain a quality of service (QOS) parameter indicating timing of transmission of the message should be dependent on delivery of the first set of packets to the UE.

18. The apparatus of claim 13, wherein the at least one action comprises transmitting a message for a conditional handover, wherein the message indicates the UE can perform the handover conditional upon completion of delivery of the first set of packets to the UE.

19. The apparatus of claim 18, wherein the conditional handover message is transmitted prior to detecting a condition to trigger handover of UE from a serving cell to a target cell.

20. The apparatus of claim 18, wherein the handover is also conditioned on random access channel (RACH) occasion (RO) timing of the target cell.

21. The apparatus of claim 18, wherein the conditional handover message identifies at least one of:
the first set of packets; or
a burst of sets of packets that includes the first set of packets.

22. The apparatus of claim 18, wherein the handover is also conditioned on at least one of:
the UE receiving signaling from the first network entity indicating an end of traffic; or
the UE entering at least one of a physical downlink control channel (PDCCH) skipping mode or a sleep mode.

23. The apparatus of claim 18, wherein the handover is also conditioned on completion of at least one uplink transmission from the UE to the first network entity.

24. The apparatus of claim 18, wherein the message also indicates the UE can perform the conditional handover prior to completion of delivery of the first set of packets to the UE, based upon at least one of:
expiration of a timer; or
a channel condition threshold.

25. The apparatus of claim 13, wherein:
the first set of packets has a delay budget; and
the one or more processors are further configured to execute the computer-executable instructions and cause the apparatus to transmit an indication of a remainder of the delay budget to a second network entity of the target cell, if the handover occurs prior to completion of delivery of the first set of packets to the UE.

26. The apparatus of claim 13, wherein the at least one action comprises transmitting at least one of a physical downlink control channel (PDCCH) or medium access control (MAC) control element (CE) that indicates when the handover should be triggered.

27. The apparatus of claim 13, wherein:
the at least one action comprises transmitting a handover message that indicates handover timing dependent on delivery of the first set of packets to the UE; and
the one or more processors are further configured to execute the computer-executable instructions and cause the apparatus to participate in handover preparation with a second network entity of the target cell after transmitting the handover message.

28. A method for wireless communications by a user equipment (UE), comprising:
receiving, from a first network entity, a message indicating a handover of the UE from a source cell to a target cell; and
performing the handover conditional upon completion of delivery of the first set of packets from the first network entity to the UE.

29. A method for wireless communications by a first network entity, comprising:
obtaining a first set of packets to be delivered to a user equipment (UE); and
performing at least one action to delay handover of the UE from a serving cell to a target cell until completion of delivery of the first set of packets to the UE.
